(19) United States
(12) Patent Application Publication
(10) Pub. No.: US 2022/0241987 A1
(43) Pub. Date: Aug. 4, 2022

(54) GRIPPING APPARATUS

(71) Applicant: FESTO SE & CO. KG, Eslingen (DE)

(72) Inventor: Markus AEGERTER, Altbach (DE)

(73) Assignee: FESTO SE & CO. KG, Eslingen (DE)

(21) Appl. No.: 17/626,339

(22) PCT Filed: May 19, 2020
(86) PCT No.: PCT/DE2020/100435

§ 371 Date: Jan. 11, 2022

(30) Foreign Application Priority Data
Jul. 15, 2019 (DE) 10 2019 119 125.4

(51) Int. Cl. B25J 15/02

(52) U.S. Cl. CPC B25J 15/0246; B25J 15/022

(57) ABSTRACT

The present invention relates to a gripping apparatus (100) for gripping objects, comprising a sleeve-like main body (200), a permanent magnet (210) accommodated in the main body (200), and an armature element (220) which is arranged coaxially with the permanent magnet (210) and is designed to be movable between a first position close to the permanent magnet and a second position remote from the permanent magnet, wherein: the sleeve-like main body (200) comprises at least two gripping fingers (230) which are each designed to be connected to the armature element (220) by means of an actuating bar (240), and the gripping fingers (230) are moved towards one another when the armature element (220) is moved into the first position, and moved away from each other to a release position when the armature element (220) is moved into the second position; and the gripping apparatus (100) comprises a switchable coil (300) which, when in the switched state, is designed to generate a magnetic field that opposes the permanent magnet (210).

The present invention relates to a gripping apparatus for gripping objects.

Gripping apparatuses for gripping objects are well known in the prior art. Automatic pick-and-place machines in which gripping apparatuses are used for gripping components represent one example of the use of gripping apparatuses. In the case of the grippers of this type, particular requirements are set in the field of clean-room applications such as, for example, in the case of wafers, or else in the case of foodstuffs. A robotic gripper of this type is known from publication DE 102005046160 B3, and a gripping apparatus is known from publication DE 102009015975 A1.

It is disadvantageous in the prior art that known gripping apparatuses have a complicated construction, in most instances having a plurality of individual mechanical components. Negative consequences include high production costs and a high dead weight. Moreover, the known gripping apparatuses in terms of the construction and the functionality thereof are often inflexible and thus not able to be adapted to specific customer requirements without comparatively great complexity. A further disadvantage lies in that defective or worn-out grippers can be repaired or replaced only with a comparatively great complexity.

The invention is therefore based on the object of achieving an improved gripping apparatus which overcomes at least one of the disadvantages of the prior art.

This object is achieved according to the invention by a gripping apparatus according to the subject matter of claim 1.

Advantageous and expedient design embodiments of the gripping apparatus according to the invention are set forth in the dependent claims.

According to the invention, the gripping apparatus for gripping objects comprises a sleeve-type main body, a permanent magnet received in the main body, an armature element which is disposed so as to be coaxial with the permanent magnet and is configured so as to be transferable between a first position, proximal to the permanent magnet, and a second position, distal from the permanent magnet. The sleeve-type main body furthermore comprises at least two gripping fingers which by way of an activation web are in each case configured so as to be connected to the armature element. The gripping fingers, when transferring the armature element to the first position, converge to a gripping position and, when transferring the armature element to the second position, diverge to a releasing position. Additionally, the gripping apparatuses comprises a switchable coil which in the switched state is configured for generating a magnetic field that is opposed to the permanent magnet.

The advantage of the gripping apparatus according to the invention lies in that the gripping apparatus, as a result of the magnetic pull on the armature element by the permanent magnet, can carry out a gripping movement. This takes place entirely independently of external power or energy sources. The releasing movement of the gripping apparatus, however, is implemented by switching on the switchable coil. A magnetic field, the magnetic force thereof being opposed to the magnetic field of the permanent magnet, is created here. As a result, the magnetic effect on the armature element is at least neutralized, as a result of which the latter is transferred to the second position, distal from the permanent magnet, and the gripping fingers are transferred to the releasing position. A particular advantage here is derived in that the gripped item is not dropped in the event of a power failure. The gripping apparatuses thus comprises a safety function which is configured as an NC (normally closed) variant. The clutching or gripping, respectively, of the object thus takes place in the resting state since a gripped object is not dropped in the event of a drive failure, for example by virtue of an uninterrupted energy supply.

According to one preferred embodiment, the coil is disposed within the sleeve-type main body. As a result, the technical advantage that the gripping apparatus is configured so as to be particularly compact is achieved, for example. The coil can be wound about the permanent magnet, for example.

According to one further particularly preferred embodiment, the sleeve-type main body and the gripping fingers are configured in one part as an integral component. As a result, the technical advantage that the gripping apparatus can be produced in a particularly simple manner is achieved, for example. In the event of damage to the sleeve-type main body or to one of the gripping fingers, the gripping apparatus can be very easily repaired, as a result of which the interruption of the operation of the gripping apparatus caused by the repair is minimized.

According to one further embodiment, a cross section of each gripping finger in the region of a gripping finger root is configured so as to be reduced at the transition from the sleeve-type main body to the gripping finger. As a result, the technical advantage that the region of the reduced cross section is particularly easy to bend is achieved, for example. When the armature element is thus transferred to the first position, proximal to the permanent magnet, the gripping fingers by way of the activation webs are transferred to the gripping position. This takes place primarily as a result of the elastic deformation of the gripping fingers per se in the region of the deformed cross section. A further advantage results from the restoring force of the deformed gripping fingers. As soon as the magnetic force of the permanent magnet is neutralized by switching on the electric coil, the armature element as a result of the restoring force of the elastically deformed gripping fingers is transferred to the second position, distal from the permanent magnet. The restored position corresponds to the releasing position of the gripping apparatus.

According to one further preferred embodiment, each activation web comprises a solid-body articulation on the armature element side as well as on the gripping finger side. Solid-body articulations correspond approximately to film hinges and are in principle configured in one part, or so as to be integral to the two elements to be connected, respectively. Hinges of this type are composed substantially of a thin-walled connection, the latter often being in the form of a crease and as a result of the flexure thereof enabling a rotation of the connected elements. Simple and cost-effective articulated connections are provided by means of the solid-body articulations.

In order for the clamping force of the gripping apparatus to be increased, at least one fastening web is connected to the assigned gripping finger in a central region of the gripping finger, between the gripping finger root and the gripping fingertip. In one advantageous embodiment, the fastening web is connected to the gripping finger in a front region of the gripping finger, between the central region of the gripping finger and the gripping fingertip. For example, a longitudinal axis of the fastening web and the longitudinal axis of the sleeve-type main body conjointly enclose an angle of approximately 45° when the armature element is situated in the second position, distal from the permanent magnet. The closer to the gripping fingertip the fastening web is connected to the gripping finger, the better the leverage and thus the clamping force.

According to the invention, the gripping fingers are advantageously configured so as to be resilient. The elastic deformation of each gripping finger is thus not only reduced to the region on the gripping finger root that is reduced in terms of the cross section. The deformation additionally takes place along the entire gripping finger.

According to one particularly preferred embodiment, the sleeve-type main body comprises four gripping fingers. As a result of the use of four gripping fingers, items can be optimally gripped from four sides, wherein an identical gripping force is available to each gripping finger. In alternative specific applications, the gripping apparatus comprises only two or three gripping fingers. However, a larger number of gripping fingers would likewise be conceivable.

In yet another further embodiment, the sleeve-type main body has a guide groove. For example, this guide groove in relation to the main body of the gripping apparatus is aligned in an axial longitudinal direction. As a result, the guide groove can serve for disposing the sleeve-type main body on the gripping apparatus in a simplified manner. This becomes relevant in particular when replacing a worn-out or defective main body with a new main body. For example, a corresponding guide cam can be disposed on the gripping apparatus, said guide cam resulting in the main body being precisely assigned to the gripping apparatus. The assembly of a main body on the gripping apparatus is highly simplified as a result.

In order for the main body to be securely fastened to the gripping apparatus, the sleeve-type main body has a latching cam for fixing the sleeve-type main body on the gripping apparatus. For example, the latching cam can correspond with the protrusion disposed on the gripping apparatus and secures the main body against being unintentionally removed. In a further preferred embodiment, the latching cam is designed in such a manner that the latter cannot be unlocked in a destruction-free manner when the main body is removed from the gripping apparatus. In other words, when the main body is removed from the gripping apparatus the latching cam has to be snapped off. This results in the advantage that a main body cannot be reused and must be replaced by a new main body. This increases the process reliability and ensures, for example, that contaminated grippers are not reused.

According to one additional embodiment, the gripping fingers on the gripping fingertips thereof have in each case one gripping contour. The gripping contour here is preferably configured in such a manner that a gripped object is held between the gripping fingers in a recess, on a protrusion, or by means of a latching element, for example, so as to be secured against slipping. A clutching action of the object is additionally stabilized as a result. For example, the gripping contour is preferably conceived such that a force-fit/form-fit results between said gripping contour and/or between the gripping fingers and the object. The object, for example a workpiece, is picked up or gripped, respectively, even more securely as a result. A force applied to this end can thus be reduced, this leading to a reduction in terms of the energy requirement and the stress on the material.

In order for an object to be able to be gripped even more securely, the gripping fingertips are configured so as to be resilient. The restoring force by virtue of the deformed resilient gripping fingertips, additionally to the restoring force already existing as a result of the deformed gripping fingers, serves for securing the grip. For example, the elasticity of the gripping fingertips is additionally increased in comparison to the elasticity of the gripping finger body. This improves the gripping of objects and items, and thus contributes toward the reliability of the process.

In order for the gripping apparatus, and in particular the armature element, to be protected against dirt, the sleeve-type main body has a protective element which is disposed so as to be coaxial with the armature element. A surface of the protective element runs so as to be orthogonal to the longitudinal axis of the gripping apparatus. Said surface of the protective element prevents any direct access to the armature element.

According to one further embodiment, the sleeve-type main body has a receptacle for the armature element, wherein the receptacle by way of the activation webs is connected to the gripping fingers. For example, the armature element can be adhesively bonded to the receptacle. Depending on the production method, the armature element can also be disposed on the receptacle by insert-molding. The receptacle enables the armature element to be fixed and supported, wherein the receptacle per se by way of the solid-body articulations is connected to the activation webs.

The receptacle, the activation web, the gripping fingers and the sleeve-type main body are particularly preferably produced integrally from one material. Furthermore preferably, the protective element is configured so as to be connected to the receptacle. The protective element here can be disposed on the gripping apparatus from below, after the main body has been assembled. Alternatively however, the protective element is also produced integrally from one material so as to be integral to the component parts comprising the receptacle, the activation webs, the gripping fingers and the sleeve-type main body.

According to the invention, the sleeve-type main body is advantageously produced by means of a generative manufacturing method. The generative manufacturing method, also referred to as 3D printing or additive manufacturing, enables a three-dimensional configuration of a product, based directly on predefined construction data, in a single operative step. Once the operative step has been completed, a three-dimensional integral product in one piece is created, the latter being ready for immediate use without any further complexity in terms of the assembly.

Alternatively thereto, the main body can also be produced by an injection-molding method. Fiber reinforced plastics materials can be expediently used here in order for the service life of the main body to be additionally increased. Glass-fiber reinforced or carbon-fiber reinforced plastics material are suitable to this end, for example.

Exemplary embodiments of the invention are illustrated in the drawings and will be explained in more detail hereunder.

In the drawings:

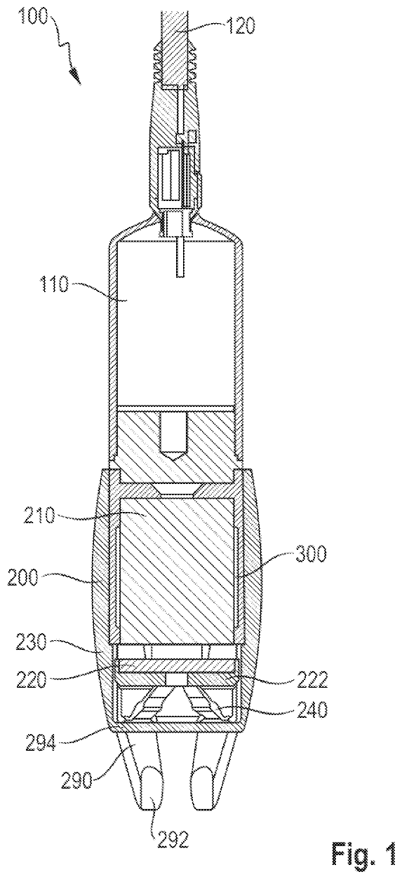

FIG. 1 shows a sectional illustration of a gripping apparatus; and

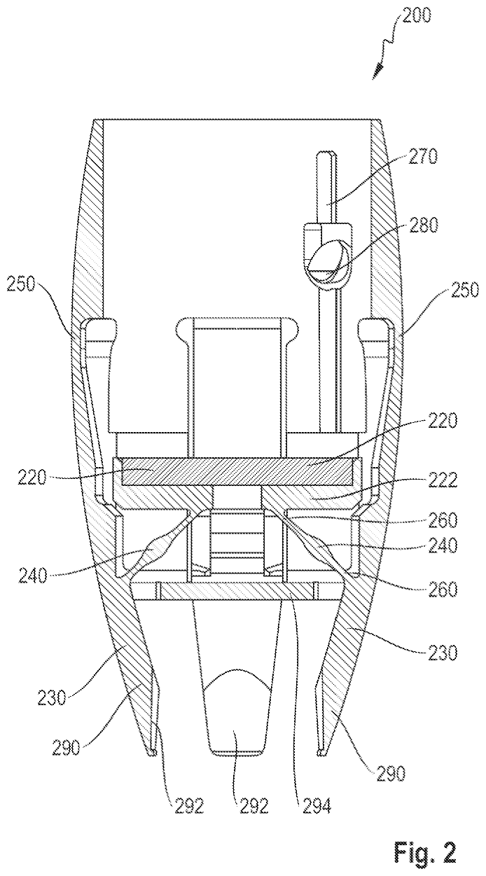

FIG. 2 shows a sectional illustration of a sleeve-type main body.

FIG. 1 shows a sectional illustration of a gripping apparatus 100. The gripping apparatus 100 comprises a gripping apparatus body 110 which at the upper end thereof has a connector 120. The connector 120 can include a power supply, for example. Furthermore, control signals for operating the gripping apparatus 100 can be fed by way of the connector 120. A sleeve-type main body 200 which is configured for implementing the gripping movement is disposed on a lower portion of the gripping apparatus 100. A permanent magnet 210 which is operatively connected to an armature element 220 is disposed within the main body 200. The armature element 220 is disposed so as to be coaxial with the permanent magnet 210 and by the magnetic pull of the permanent magnet 210 can be transferred to a first position, proximal to the permanent magnet. The armature element 220, counter to the magnetic pull of the permanent magnet 210, is transferable to a second position, distal from the permanent magnet. The first position and the second position of the armature element 220 define the range of movement in which the armature element 220 can move. The armature element 220 is produced from a ferromagnetic material such as iron or steel, for example.

A switchable coil 300 which in the switched state is configured for generating a magnetic field is additionally situated in the region of the permanent magnet 210. The magnetic field of the switchable coil 300 in the switched state is opposed to the magnetic field of the permanent magnet 220, neutralizing the magnetic field of the latter in such a manner that a resultant magnetic force no longer acts on the armature element 220. The magnetic field that predefines the position of the armature element 220 can thus be determined by switching on and off the switchable coil 300. When the switchable coil 300 is situated in a non-energized, non-switched state, the magnetic force of the permanent magnet 210 acts on the armature element 220 and transfers the latter to the first position, proximal to the permanent magnet. When the switchable coil 300 is energized and is thus situated in a switched-on state, the magnetic force of the permanent magnet 210 is neutralized and the armature element 220 by a restoring force of the deformed gripping fingers 230 is transferred to the second position, distal from the permanent magnet.

The armature element 220 is likewise disposed within the sleeve-type main body 200 and is mounted in a receptacle 222. The receptacle 222 by means of an activation web 240 is in each case connected to an assigned gripping finger 230. In the embodiment according to FIG. 1, the gripping apparatus 100 comprises a total of four gripping fingers 230 which are in each case connected to the receptacle 222 by way of one activation web 240. A protective element 294 which protects the interior of the gripping apparatus 100 against contamination is situated below the receptacle 222.

Gripping fingertips 290 which have in each case one gripping contour 292 are disposed on the lower end of the gripping fingers 230. For improved gripping of objects or items, the gripping fingertips 290 are configured so as to be resilient.

The sleeve-type main body 200 is configured so as to be removable from the gripping apparatus 100, as a rapid response is thus possible in the event of wear or a defect. The sleeve-type main body 200 is thus configured as a consumable part, whereas the gripping apparatus 100 is configured longer operating life.

FIG. 2 shows a sectional illustration of a sleeve-type main body 200 which, as according to FIG. 1, can be disposed on a gripping apparatus. The sleeve-type main body 200 according to this embodiment comprises a total of four gripping fingers 230, whereby only three gripping fingers 230 are illustrated by virtue of the sectional illustration. The sleeve-type main body 200 at an upper end comprises a cylindrical portion proceeding from which the gripping fingers 230 extend in a longitudinal direction.

A guide groove 270 in a longitudinal direction of the main body 200 is configured on the cylindrical portion of the main body 200. The guide groove 270 simplifies the disposal of the main body 200 on the gripping apparatus 100. This is of greater relevance when assembling the gripping apparatus 100 and when replacing the sleeve-type main body 200. The sleeve-type main body 200 additionally has a latching cam 280. The latching cam 280 serves for fixing the main body 200 on the gripping apparatus 200. The gripping apparatus 100 to this end comprises a corresponding protrusion which is configured for engaging the latching cam 280. As a result, the main body 200 is securely fixed on the gripping apparatus 100.

A gripping finger root 250 is situated in the region of a transition from the cylindrical portion of the main body 200 to the individual gripping fingers 230. The gripping finger root 250 possesses a locally reduced cross section so as to increase the flexure of the elastically designed gripping fingers 230. As a result of the reduced cross section, the largest deformation on the entire gripping finger 230 is in the region of the gripping finger root 250.

A space which is delimited laterally by the gripping fingers 230 and toward the bottom by a protective element 294 is situated within the sleeve-type main body 200 and below the cylindrical portion. The armature element 220 which is supported by a receptacle 222 is situated within this space. The armature element 220 and the receptacle 222 conjointly move up and down between the first position and the second position within the space. The gripping apparatus 100 here operates in an entirely wear-free manner, and the armature element 220 while moving does not directly contact, apart from the receptacle 222, any other component part of the gripping apparatus 100. Activation webs 240 which are in each case assigned to a gripping finger 230 and connected to the latter are situated on a lower side of the receptacle 222.

Each individual activation web 240 on the upper side thereof is connected to the receptacle 222, and on the lower side thereof to a gripping finger 230, by way of a solid-body articulation 260. The solid-body articulation 260 permits a movement of the armature element 220, or of the receptacle 222 supporting the armature element 220, respectively, to be transmitted in a wear-free manner to the gripping fingers 230. The gripping fingers 230 for a gripping movement are thus converged when the armature element 220 by the magnetic force of the permanent magnet 210 is transferred to the first position, proximal to the permanent magnet. This takes place in that the transfer of the armature element 220 to the first position is transmitted to the gripping fingers 230 by way of the receptacle 222 and the activation webs 240.

Accordingly, the gripping fingers 230 are diverged to a releasing position when the armature element 220 is transferred to the second position, distal from the permanent magnet. This takes place in that the coil 300 is switched on, as a result of which a magnetic field is built up, the latter being opposed to the magnetic field of the permanent magnet 210 and thus at least neutralizing the latter. The restoring force of the elastically deformed gripping fingers 230 transfers the receptacle 222, by way of the activation webs 240, back to the second position, distal from the permanent magnet.

A protective element 294 which prevents the unintentional ingress of dirt is situated below the receptacle 222. The protective element 294 is directly connected to the receptacle 222, as a result of which the protective element 294 always moves conjointly with the armature element 220 up and down between the first and the second position.

Gripping fingertips 290 which on a side that faces the space of the sleeve-shaped main body 200 have in each case one gripping contour are situated at the lower end of the gripping fingers 230.

All features explained and shown in conjunction with individual embodiments of the invention can be provided in various combinations in the subject matter according to the invention in order for the advantageous effects of said features to be simultaneously implemented.

The scope of protection of the present invention is defined by the claims and is not limited by the features explained in the description or shown in the figures.

### LIST OF REFERENCE SIGNS

100 Gripping apparatus
110 Gripping apparatus body
120 Connector
200 Sleeve-type main body
210 Permanent magnet
220 Armature element
222 Receptacle
230 Gripping finger
240 Activation web
250 Gripping finger root
260 Solid-body articulation
270 Guide groove
280 Latching cam
290 Gripping fingertips
292 Gripping contour
294 Protective element
300 Coil

We claim:

1. A gripping apparatus (100) for gripping objects, having:
a sleeve-type main body (200);
a permanent magnet (210) received in the main body (200);
an armature element (220) which is disposed so as to be coaxial with the permanent magnet (210) and is configured so as to be transferable between a first position, proximal to the permanent magnet, and a second position, distal from the permanent magnet; wherein
the sleeve-type main body (200) comprises at least two gripping fingers (230) which by way of an activation web (240) are in each cased configured so as to be connected to the armature element (220), and the gripping fingers (230), when transferring the armature element (220) to the first position, converge to a gripping position and, when transferring the armature element (220) to the second position, diverge to a releasing position; and wherein
the gripping apparatus (100) comprises a switchable coil (300) which in the switched state is configured for generating a magnetic field that is opposed to the permanent magnet (210).

2. The gripping apparatus (100) as claimed in claim 1, characterized in that the coil (300) is disposed within the sleeve-type main body (200).

3. The gripping apparatus (100) as claimed in claim 1, characterized in that the sleeve-type main body (200) and the gripping fingers (230) are configured in one part as an integral component.

4. The gripping apparatus (100) as claimed in claim 1, characterized in that a cross section of each gripping finger (230) in the region of a gripping finger root (250) is configured so as to be reduced at the transition from the sleeve-type main body (200) to the gripping finger (230).

5. The gripping apparatus (100) as claimed in claim 1, characterized in that each activation web (240) comprises a solid-body articulation (260) on the armature element side as well as on the gripping finger side.

6. The gripping apparatus (100) as claimed in claim 1, characterized in that the gripping fingers (230) are configured so as to be resilient.

7. The gripping apparatus (100) as claimed in claim 1, characterized in that the sleeve-type main body (200) comprises four gripping fingers (230).

8. The gripping apparatus (100) as claimed in claim 1, characterized in that the sleeve-type main body (200) has a guide groove (270).

9. The gripping apparatus (100) as claimed in claim 1, characterized in that the sleeve-type main body (200) has a latching cam (280) for fixing the sleeve-type main body (200) on the gripping apparatus (100).

10. The gripping apparatus (100) as claimed in claim 1, characterized in that the gripping fingers (230) on the gripping fingertips (290) thereof have in each case one gripping contour (292).

11. The gripping apparatus (100) as claimed in claim 1, characterized in that the gripping fingertips (290) are configured so as to be resilient.

12. The gripping apparatus (100) as claimed in claim 1, characterized in that the sleeve-type main body (200) has a protective element (294) which is disposed so as to be coaxial with the armature element (220).

13. The gripping apparatus (100) as claimed in claim 1, characterized in that the sleeve-type main body (200) has a receptacle (222) for the armature element (200), wherein the receptacle (222) by way of the activation webs (240) is connected to the gripping fingers (230).

14. The gripping apparatus (100) as claimed in claim 13, characterized in that the protective element (294) is configured so as to be connected to the receptacle (222).

15. The gripping apparatus (100) as claimed in claim 1, characterized in that the sleeve-type main body (200) is produced by means of a generative manufacturing method.
